(19) United States
(12) Patent Application Publication
(10) Pub. No.: US 2006/0136311 A1
(43) Pub. Date: Jun. 22, 2006

(54) Intellectual charging management system and method for a website

(76) Inventors: Leger Wu, Dajie Beijing (CN); Pinky Ma, Dajie Beijing (CN); Zechary Chang, Taipei (TW)

Correspondence Address: HDSL, 4331 STEVENS BATTLE LANE, FAIRFAX, VA, 22033, US

(21) Appl. No.: 11/014,586

(22) Filed: Dec. 17, 2004

(51) Int. Cl. G06F 17/60

(52) U.S. Cl. 705/34

(57) ABSTRACT

An intellectual charging management system and method for automatically adjusting the cost for visiting a website according to network performance for each individual user. The network performance is determined based on the actual network access speed when the user visits the website, while the cost is calculated based on network performance. The network performance and the estimated cost can be provided to the user before the user uses the service provided by the website. In addition, the cost and cost estimation are automatically refreshed at a predetermined time interval, such that the real cost can properly reflect the network access speed in real time.

### BACKGROUND OF THE INVENTION

The invention relates to a charging management system and method for a website, and more particularly to an intellectual charging management system and a method for a website.

As the internet becomes more and more popular, many users start enjoying the convenient and entertaining contents it provides. Bandwidth can ultimately be increased, and lengthy data transmission can be performed by the network. Consequently, problems relating to on-line charges can occur.

Indeed, much enjoyment has been provided by the network; however, such enjoyment is not established for free. It is often that the user spends a significant amount of money for a slow-speed connection. Sometimes, documents downloaded with wide-band connection speed are similar to a dial-up service, and downloaded movies play like slow motion. Sometimes the connection is too slow to play the movie. Users are charged the same exorbitant fee for network performance like this. Therefore, many of the current charging methods are not reasonable. Some networks charge the users based on the data flow, which indicates that more money is required for large bandwidth. However, a majority of network or service providers still charge for connection time. In such a manner, the users who have less service are always the ones who pay more. There is thus a substantial need to provide a more reasonable on-line charge management system and method to overcome the above-mentioned problems.

### BRIEF SUMMARY OF THE INVENTION

To resolve the above drawbacks, an intellectual charging management system and method is provided. The charging mechanism is automatically adjusted in response to the connection speed of the user, such that the payment of the user is proportional to the service provided. Particularly during internet rush hours, the users will not be charged more by waiting.

The intellectual charging management system and method as provided automatically adjusts the cost for visiting a website according to network performance for each individual user. The network performance is determined based on the actual network access speed when the user visits the website, while the cost is calculated based on the network performance. The network performance and the estimated cost can be provided to the user before the user uses the service provided by the website. In addition, the cost and cost estimation are automatically refreshed at a predetermined time interval, such that the real cost can properly reflect the network access speed in real time.

### BRIEF DESCRIPTION OF THE DRAWINGS

The above objects and advantages of the invention will become more apparent with the following detailed description of the exemplary embodiments thereof with reference to the attached drawings in which:

FIG. 1 shows the structure of various modules of an intellectual charging management system of a website;

FIG. 2 shows the additional modules of the intellectual charging management system;

FIG. 3 is a flow chart showing an intellectual charging method of a website; and

FIG. 4 shows the detailed process of the charging method.

### DETAILED DESCRIPTION OF THE INVENTION

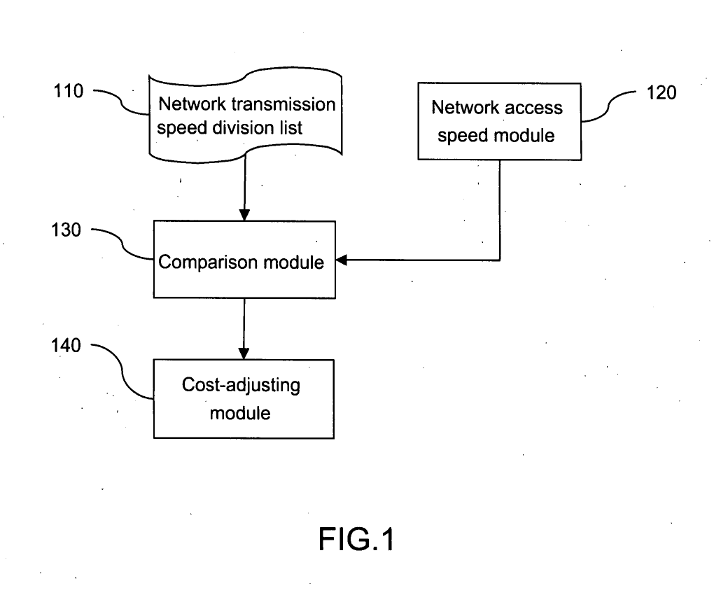

Referring to FIG. 1, the module structure of a charging management system of an intellectual network is provided. The module comprises a network connection speed division list 110, a network access speed module 120, a comparison module 130, and a cost-adjusting module 140. Each of these modules will be described in detail as follows. The network transmission speed division list 110 basically divides the network transmission speed of the user into several divisions and stores them in a memory unit. Thereby, the cost can be calculated based on the individual network transmission speed. Based on the currently available network connection speeds, a standard network connection speed is about 30 Kbit/sec. The individual network transmission speed is then divided or categorized with reference to such standard network transmission speed. In this embodiment, the network performance is considered slow when the transmission speed is slower than 10 Kbit/second, and relatively slow when the transmission speed is between 10 Kbit/second and 20 Kbit/second. For the transmission speed between 30 Kbit/second and 40 Kbit/second, the network performance is considered relatively fast, and the transmission speed higher than 40 Kbit/second means the network performance is fast. A Table of the list can be saved as:

TABLE I

| Data Transmission Speed | |
|---|---|
| (Kbit/second) | Network Performance |
| Up to 10 | Slow |
| 10-20 | Relatively Slow |
| 20-30 | Normal |
| 30-40 | Relatively Fast |
| Over 40 | Fast |

The network access speed module 120 includes a network speed detector, which detects the speed when the user visits a specific website. When the user visits the website at different time, the access speed is very likely different. Likewise, when a user visits different websites at the same time, the access speed may also vary. Many factors will affect the access time, including locally occurring viruses, server conditions, parameters of the local system, operating conditions of CPU, etc. The network speed detector operates to detect the index of various bandwidths using scientific calculations. The access speed of each individual user can be tested via such on-line testers to monitor the network condition. The user can also install such a module in his or her own machine to perform test of transmission speed and send the test result to the comparison module for comparison.

The comparison module 130 then compares the tested result obtained by the network access speed module 120 to the network transmission speed division list 110, so as to determine the group to which the current user belongs. The comparison results provide an indication of the network performance to the user, who can then decide whether the website should be visited or not according to the network performance.

The cost-adjusting module 140 provides cost calculation according to the network performance provided by the network transmission speed division list 110. The service provider can determine how to charge the user based on the network performance as detected. Therefore, when the user has slow or relatively slow network performance for visiting a specific website, the service provider can determine whether the user will be charged less because of poor network performance. The user will then be charged in a more reasonable way. In addition to the above, the system may further comprise an automatic refresh module 150 and a hint module 160.

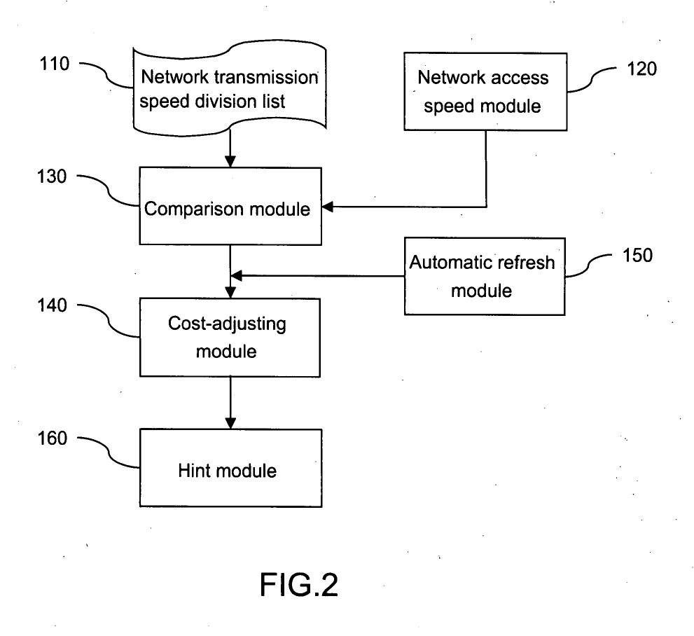

Referring to FIG. 2, the automatic refresh module 150 automatic refreshes the cost calculation during a predetermined time interval. Therefore, when the network access speed varies, the cost is refreshed accordingly to avoid overcharging or undercharging. In this embodiment, the time interval is set at 3 seconds. That is, the network performance is tested every 3 seconds by detecting the network access speed and comparing the detected result to the network transmission speed division list 110.

The hint module 160 is used to provide the current network access speed and the cost that may be incurred for visiting a specific website. The user can thus determine whether the website should be visited based on the network performance and the cost, or the amount of time to visit the website.

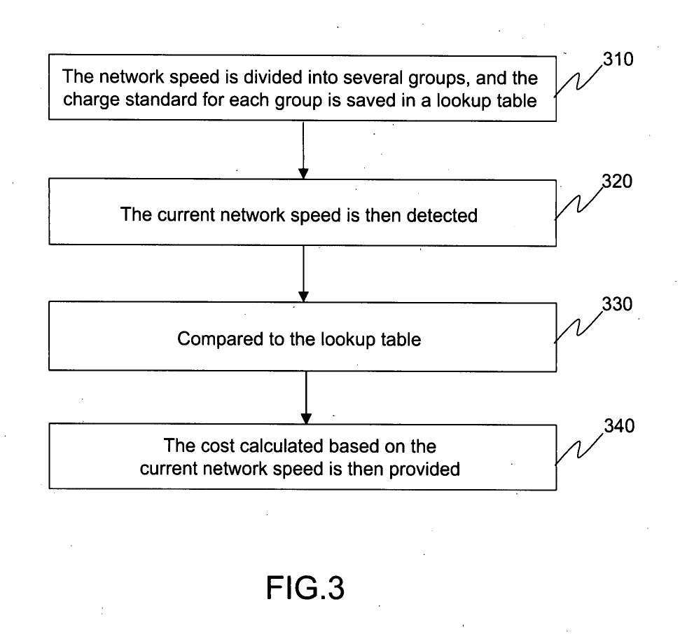

FIG. 3 illustrates a process flow for the charging management system and method as provided above. In step 310, the network speed is divided into several groups, and the charge standard for each group is saved in a lookup table. The current network speed is then detected in step 320, and compared to the lookup table in step 330. The cost calculated based on the current network speed is then provided in step 340.

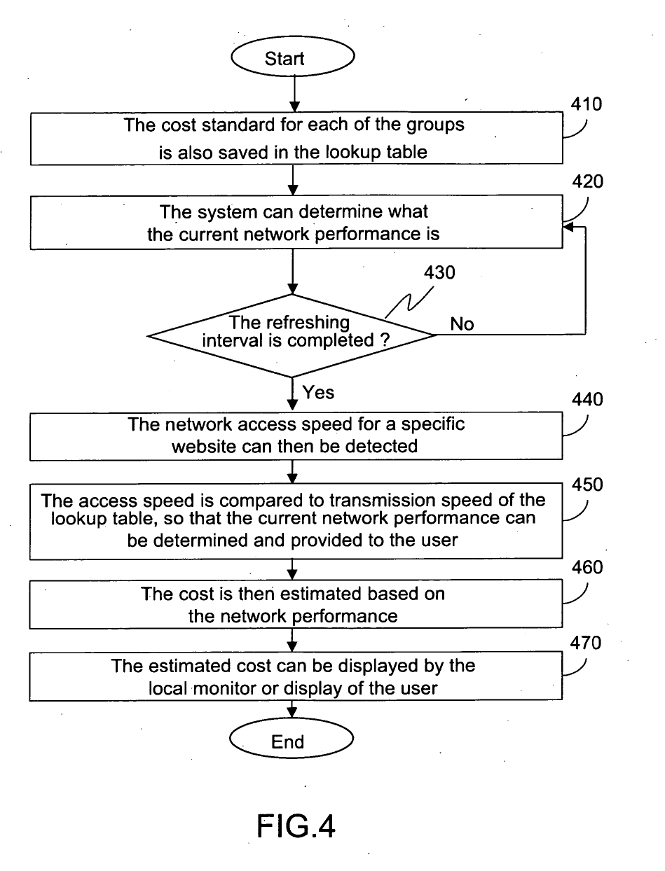

Referring to FIG. 4, in the management system and method as described above, a server is used to divide the network speed into several grades or groups, and save the grades into a lookup table. The cost standard for each of the groups is also saved in the lookup table in step 410. Table I shows an example for the grades.

When the user logs onto the internet, the system can determine what the current network performance is in step 420, and refreshes the cost evaluated based on the network performance. When the refreshing interval is completed in step 430, the cost calculation program is activated to refresh the cost. In this embodiment, the refreshing interval is set at 3 seconds.

The network access speed for a specific website can then be detected in step 440. All users can use a network access speed module provided by the website to detect the access speed, so as to estimate the cost incurred by visiting the website.

The access speed is compared to transmission speed of the lookup table, so that the current network performance can be determined and provided to the user in step 450. The cost is then estimated based on the network performance in step 460. The estimated cost can be displayed by the local monitor or display of the user in step 470.

Therefore, the service provider can adjust the cost for each individual user based on the network speed and actual visit time of the website. For example, when the user has a relatively slow network performance, although the time used for visiting the website is relatively long, the cost may be less because of relatively slow network performance. The user may thus be more willing to use the service provided by the website.

While the invention has been shown and described with reference to preferred embodiments thereof, it will be understood by those skilled in the art that various changes in form and details may be made therein without departing from the spirit and scope of the invention as defined by the appended claims.

What is claimed is:

1. An intellectual charging management for evaluating cost of visiting a website, comprising:
a network access speed module for detecting an access speed for visiting the website;
a lookup table, providing a plurality of network performance grades determined based on various access speed ranges and a plurality of cost standards for the respective network performance grades;
a comparison module, determining the network performance grade for the access speed detected by the network access speed module; and
a cost-adjusting module, calculating the cost for visiting the website according to cost standard of the network performance.

2. The system of claim 1, further comprising an automatic refreshing module for refreshing calculation of the cost for a predetermined time interval.

3. The system of claim 2, wherein the predetermined time interval is 3 seconds.

4. The system of claim 1, further comprising a hinting module to indicate the cost calculated by the cost-adjusting module.

5. The system of claim 1, wherein the network performance includes slow grade, relatively slow grade, normal grade, relatively fast grade and fast grade.

6. A method of intellectually charging a user for visiting a website, comprising:
dividing network access speed into a plurality of network performance grades, and determining a cost standard for each network performance grade;
detecting a current network access speed of the user for accessing the website;
determining the network performance grade of the current network access speed; and
calculating cost for accessing the website according to the network performance grade.

7. The method of claim 6, further comprising refreshing the cost in accordance with the network performance for every predetermined time interval.

8. The method of claim 7, wherein the predetermined time interval is 3 seconds.

9. The method of claim 6, further comprising providing the calculated cost to the user after the setup of calculating cost for accessing the website according to the network performance grade.

10. The method of claim 6, wherein the network performance grades includes a slow grade, a relatively slow grade, a normal grade, a relatively fast grade, and a fast grade.
